(19) United States
(12) Patent Application Publication
(10) Pub. No.: US 2014/0002477 A1
(43) Pub. Date: Jan. 2, 2014

(54) APPARATUS AND METHOD FOR TRANSFORMING LUMINANCE OF IMAGE DATA IN A TERMINAL

(71) Applicant: Samsung Electronics Co., Ltd., Gyeonggi-do (KR)

(72) Inventor: Tomasz STANISLAWSKI, Warsaw (PL)

(21) Appl. No.: 13/933,820

(22) Filed: Jul. 2, 2013

(30) Foreign Application Priority Data
Jul. 2, 2012 (KR) 10-2012-0071833

(51) Int. Cl. G09G 5/02

(52) U.S. Cl. CPC G09G 5/02
USPC 345/589

(57) ABSTRACT

An apparatus and method for transforming luminance of image data in a terminal are provided, in which a memory stores image data of at least one image, and a controller linearly approximates coefficients included in a macro block of the image data and generates image data with a changed luminance, taking into account the linearly approximated coefficients.

### PRIORITY

This application claims priority under 35 U.S.C. §119(a) to a Korean Patent Application filed in the Korean Intellectual Property Office on Jul. 2, 2012 and assigned Serial No. 10-2012-0071833, the contents of which are incorporated herein by reference.

### BACKGROUND OF THE INVENTION

1. Field of the Invention

The present invention relates to a terminal, and more particularly, to an apparatus and method for transforming the luminance of image data in a terminal.

2. Description of the Related Art

To improve image quality, a luminance curve is generally transformed. Luminance curve transformation is used for various applications including gamma correction, contrast or brightness control.

For luminance transformation, function values should be calculated for the pixels of image data. However, computation of the per-pixel function values decreases the speed of luminance transformation. Moreover, since the per-pixel function values should be calculated in the spatial domain, a large amount of memory capacity is consumed. Accordingly, there exists a need for a method to solve his problem.

### SUMMARY OF THE INVENTION

An aspect of embodiments of the present invention is to address at least the problems and/or disadvantages and to provide at least the advantages described below. Accordingly, an aspect of embodiments of the present invention is to provide an apparatus and method for transforming the luminance of image data in a terminal so as to achieve good image quality.

Another aspect of embodiments of the present invention is to provide an apparatus and method for transforming the luminance of image data in a terminal in order to enable high-speed computation.

A further aspect of embodiments of the present invention is to provide an apparatus and method for transforming the luminance of image data in a terminal, while reducing memory consumption.

In accordance with an embodiment of the present invention, there is provided an apparatus for transforming luminance of image data in a terminal, in which a memory stores image data of at least one image, and a controller linearly approximates coefficients included in a macro block of the image data and generates image data with a changed luminance, taking into account the linearly approximated coefficients.

In accordance with another embodiment of the present invention, there is provided a method for transforming luminance of image data in a terminal, in which coefficients included in a macro block of pre-stored image data are linearly approximated, and image data with a changed luminance is generated, taking into account the linearly approximated coefficients.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram of a terminal according to an embodiment of the present invention;

FIG. 2 illustrates a macro block according to an embodiment of the present invention;

FIG. 3 illustrates linear approximation of a non-linear function according to an embodiment of the present invention;

FIG. 4 illustrates macro block transformation according to an embodiment of the present invention;

FIG. 5 is a flowchart illustrating an operation for transforming the luminance of image data in a terminal according to an embodiment of the present invention;

FIG. 6 is a flowchart illustrating an operation for correcting a macro block in a terminal according to an embodiment of the present invention; and

FIG. 7 illustrates image data with transformed luminance according to an embodiment of the present invention.

### DETAILED DESCRIPTION OF EMBODIMENTS OF THE INVENTION

Reference will be made to embodiments of the present invention with reference to the attached drawings. A detailed description of generally known functions and structures of the present invention will be avoided if it obscures the subject matter of the present invention. Throughout the drawings, the same drawing reference numerals will be understood to refer to the same elements, features and structures.

In accordance with an embodiment of the present invention, a terminal refers to a desktop computer and a portable terminal. The portable “terminal” is an electronic device that is readily carried by a user, and can be any of a video phone, a portable phone, a smart phone, an International Mobile Telecommunication 2000 (IMT-2000) terminal, a Wideband Code Division Multiple Access (WCDMA) terminal, Universal Mobile Telecommunication System (UMTS) terminal, a Personal Digital Assistant (PDA), a Portable Multimedia Player (PMP), a Digital Multimedia Broadcasting (DMB) terminal, an e-book reader, a portable computer (e.g. a notebook or tablet PC), a digital camera, etc.

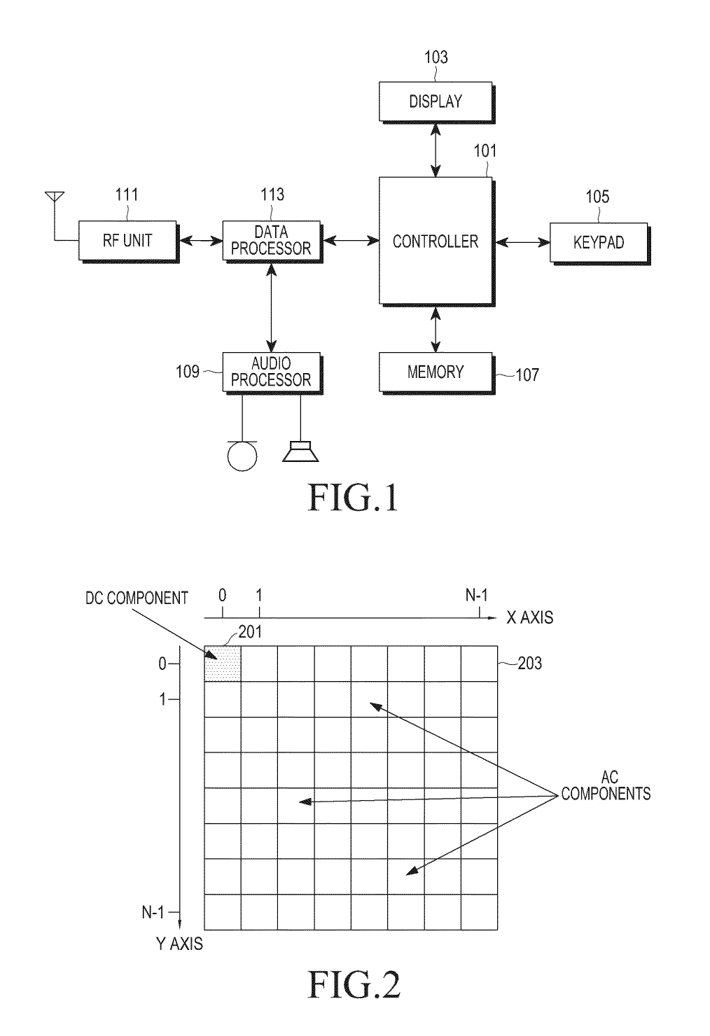

Referring to FIG. 1, a portable terminal includes a controller 101, a display 103, a keypad 105, a memory 107, an audio processor 109, a Radio Frequency (RF) unit 111, and a data processor 113.

The RF unit 111 controls a wireless communication function of the portable terminal. Specifically, the RF unit 111 includes an RF transmitter for upconverting the frequency of a transmission signal and amplifying the upconverted transmission signal, and an RF receiver for low-noise-amplifying a received signal and downconverting the frequency of the low-noise-amplified signal. The data processor 113 includes a transmitter for encoding and modulating a transmission signal and a receiver for demodulating and decoding a received signal. The data processor 113 may include a MODEM and a CODEC and the CODEC may include a data CODEC for processing packet data and an audio CODEC for processing an audio signal.

The audio processor 109 reproduces a received audio signal output from the data processor 113 through a speaker or transmits a transmission audio signal generated from a microphone. The keypad 105 includes alphanumerical keys for inputting digits and characters and function keys for setting functions. The display 103 displays a video signal and data upon request of the controller 101.

If the display 103 is a capacitive or resistive touch screen, the keypad 105 may include a predetermined minimum number of keys and the display 103 may also provide a partial key input function. Particularly it is assumed that the display 103 is configured as a touch screen type according to the present invention.

The memory 107 includes a program memory and a data memory. The program memory stores a booting program and an Operating System (OS) to control typical functionalities of the portable terminal and the data memory stores data generated during operations of the portable terminal. In particular, the memory 107 pre-stores image data.

The controller 101 provides overall control to the portable terminal. Particularly, the controller 101 quickly corrects the luminance of image data, consuming a small memory capacity and achieving good image quality in spite of fast luminance correction.

More specifically, the controller 101 receives compressed image data from the memory 107, parses the received image data, and decompresses the image data. For example, the image data may be any of a Joint Photographic Experts Group (JPEG), RAW, Tagged Image File Format (TIFF), or Bit Map (BMP) file.

The controller 101 acquires image parameters by analyzing the header of the image data and detects a macro block from the image data by decoding the decompressed image data in a predetermined decoding scheme. The controller 101 may use Huffman decoding in decoding the decompressed image data. Huffman decoding is based on Huffman coding, which is a type of entropy coding used for lossless data compression. Huffman coding uses a variable-length code according to the frequencies of occurrence of a set of data symbols (a character). The term, “macro block” refers to a prediction unit being a group of pixel elements for motion compensation and motion prediction.

FIG. 2 illustrates the structure of a macro block. Referring to FIG. 2, a macro block includes a DC component 201 and AC components 203. The coefficient of the DC component 201 is the average coefficient of the whole macro block and the coefficient of each AC component 203 is a variation relative to the average coefficient in the AC component 203. The DC component 201 may be located in position 1×1 of the macro block.

While the macro block is of size 8×8 in FIG. 2, this is purely an example, and the macro block may have a size of 4×4 or 16×16.

The controller 101 performs a zigzag operation on each component of the macro block. The zigzag operation permutes the coefficients of the components. The controller 101 dequantizes each component of the macro block by multiplying a number included in a look-up table by the coefficient of the component.

Then the controller 101 corrects the luminance of the image data by transforming the coefficients of the components of the macro block.

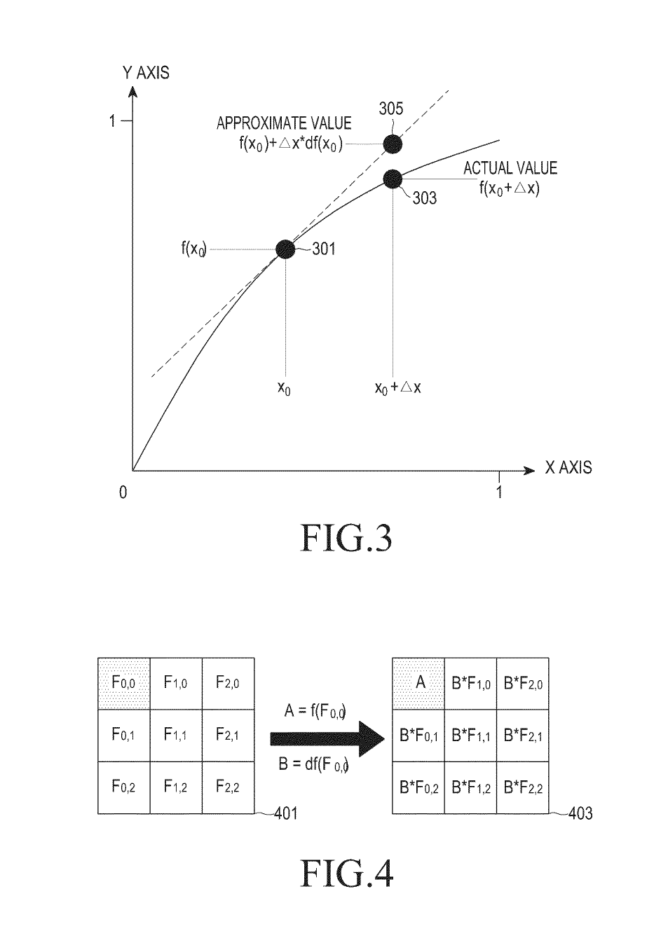

FIG. 3 illustrates a non-linear function representing gamma related to the luminance of image data. The non-linear function is approximated by means of a linear approximation formula which may be expressed as Equation (1):

$$f ( {x}_{0} + Δ x ) = f ( {x}_{0} ) + Δ x \cdot \frac{d f}{d x} ( {x}_{0} ) \qquad ( 1 )$$

where

$$\frac{d f}{d x} ( {x}_{0} )$$

is the derivative of the function f(x) at a point ( ).

Referring to FIG. 3, a solid line represents the non-linear function and a dotted line represents a linear function obtained by approximating the non-linear function. The controller 101 calculates a linear function contacting the non-linear function at a specific point. This point of the linear function is very close to a specific point of the non-linear function. For example, if a specific point is x₀ denoted by reference numeral 301, ƒ(x₀)+Δx·dƒ(x₀) denoted by reference numeral 305 may be very close to ƒ(x₀)+Δx denoted by reference numeral 303.

The intensity of a block at position (x, y) in the macro block may be expressed as the sum of the average value V_{DC} of the macro block and a small difference ΔV(x,y). That is, the intensity of the macro block may be determined by Equation (2):

V(x,y)=V_{DC}+ΔV(x,y) (2)

where V_{DC} denotes the average intensity of the components of the macro block.

To apply Equation (2) describing the intensity of a macro block to Equation (1), x₀ in Equation (1) is replaced with V_{DC} in Equation (2) and Δx in Equation (1) is replaced with ΔV(x, y) in Equation (2). Then Equation (1) may be given as Equation (3):

$$f ( V ( x , y ) ) \approx f ( {V}_{DC} ) + \frac{d f}{d x} ( {V}_{DC} ) \cdot Δ V ( x , y ) \qquad ( 3 )$$

Equation (3) reveals that the non-linear transformation of the luminance values of pixels in a macro block can be efficiently approximated by scaling AC coefficients at a specific point Δƒ(V_{DC}). Here, the DC component 201 is equal to ƒ(V_{DC}) in a transformed macro block.

To approximate a non-linear function representing luminance to a linear-function by Equation (3), if a macro block is of size N×N, the controller 101 sets the coefficient of a specific point (x, y) in the macro block to F_{IN}(x,y) and sets the coefficient of the DC component in the macro block to F_{IN}(0,0). Here, it is assumed that 0≦x≦N and 0≦y<N.

The controller 101 scales the DC component of the macro block to a value ranging from 0 to 1, as expressed as Equation (4):

V_{DC}=scale(F_{IN}(0,0)) (4)

Then the controller 101 calculates a luminance transformation function for the DC component. In the case where the gamma of image data is compensated for luminance transformation, the luminance transformation function is a mechanism that approximates a function f(x)=x^{g} where g is a gamma value. The luminance transformation function of the DC component may be given as Equation (5):

A=ƒ(V_{DC}) (5)

The controller 101 calculates the derivative of the luminance transformation function at V_{DC}. In the case where the gamma of image data is compensated for luminance transformation, the derivative of the luminance transformation function is a mechanism that approximates a derivative function df(x)=g×x^{g} where g is a gamma value. The derivative of the luminance transformation function at V_{DC} may be given as Equation (6):

B=dƒ(V_{DC}) (6)

The controller 101 calculates the coefficient F_{OUT}(x,y) of the components of the macro block using the derivative of the luminance transformation function.

The controller 101 calculates the coefficient of the DC component using Equation (7):

F_{OUT}(0,0)=unscale(A) (7)

where unscale(A) is the inverse function of the function A.

The controller 101 calculates the coefficients of the AC components using Equation (8):

F_{OUT}(x,y)=B·F_{IN}(x,y) (8)

In this manner, the controller 101 can correct the coefficients of the macro block using Equations (7) and (8).

FIG. 4 illustrates macro block transformation according to an embodiment of the present invention.

Referring to FIG. 4, first and second macro blocks 401 and 403 are of size 3×3.

The controller 101 corrects the first and second macro blocks 401 and 403 using Equations (7) and (8). To be more specific, the controller 101 corrects the coefficient F_{0,0} of a DC component included in the first macro block 401 to the coefficient A of a DC component included in the second macro block 403 using Equation (7). Then the controller 101 corrects the coefficients F_{1,0}, F_{2,0}, F_{0,1}, F_{1,1}, F_{2,1}, F_{0,2}, F_{1,2}, and F_{2,2} of AC components included in the first macro block 401 to B·F₁₀, B·F₂₀, B·F_{0,1}, B·F_{1,1}, B·F_{2,1}, B·F_{0,2}, B·F_{1,2}, and B·F_{2,2} using Equation (8).

To approximate a non-linear function representing gamma related to luminance, the controller 101 corrects the coefficients of the components of a macro block in this manner.

Then, the controller 101 quantizes each component of the macro block by dividing the coefficient of the component by a number included in a look-up table. The controller 101 performs a zigzag function on the quantized components and encodes image data including the zigzag-operated macro block. Herein, the controller 101 may encode the image data by Huffman coding. The controller 101 adds a header to the encoded image data and compresses the header-added image data.

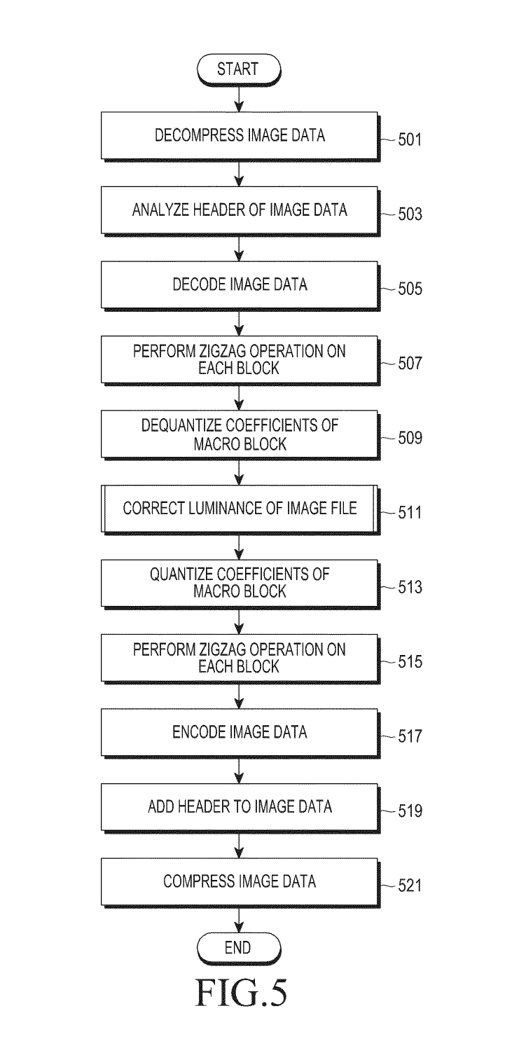

FIG. 5 is a flowchart illustrating an operation for transforming the luminance of image data in a terminal according to an embodiment of the present invention.

Referring to FIG. 5, the controller 101 receives image data, parses the received image data, and decompresses the image data based on the parsing result in step 501. For example, the image data may be any of a JPEG, RAW, TIFF, or BMP file.

The controller 101 acquires image parameters by analyzing the header of the image data in step 503, and detects a macro block from the image data by decoding the decompressed image data in a predetermined decoding scheme in step 505. The controller 101 may use Huffman decoding in decoding the image data. Huffman decoding is based on Huffman coding, and Huffman coding is a type of entropy coding used for lossless data compression. Huffman coding uses a variable-length code according to the frequencies of occurrence of a set of data symbols (a character). The term “macro block” refers to a prediction unit being a group of pixel elements for motion compensation and motion prediction.

In step 507, the controller 101 performs a zigzag operation on each component of the macro block. The zigzag operation permutes the coefficients of the components. The controller 101 dequantizes each component of the macro block by multiplying a number included in a look-up table by the coefficient of the component in step 509.

Then the controller 101 corrects the luminance of the image data by transforming the coefficients of the components of the macro block, and corrects the luminance of the image data by transforming the coefficients of components included in the macro block using Equations (7) and (8) in step 511, and then proceeds to step 513.

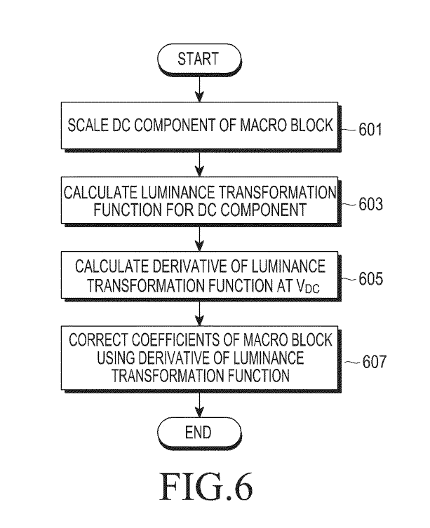

With reference to FIG. 6, step 511 will be described in greater detail. The controller 101 scales the DC component of the macro block, for example, using Equation (4) in step 601.

In step 603, the controller 101 calculates a luminance transformation function for the DC component. In the case where the gamma of image data is compensated for luminance transformation, the luminance transformation function is a mechanism that approximates a function f(x)=x^{g}, where g is a gamma value.

The controller 101 calculates the derivative of the luminance transformation function at V_{DC} in step 605. In the case where the gamma of image data is compensated for luminance transformation, the derivative of the luminance transformation function is a mechanism that approximates a derivative function df(x)=g×x^{g}, where g is a gamma value. In step 607, the controller 101 corrects the coefficients of the components of the macro block using the derivative of the luminance transformation function, for example, using Equations (7) and (8).

Referring back to FIG. 5, the controller 101 quantizes each component of the macro block by dividing the coefficient of the component by a number included in a look-up table in step 513, performs a zigzag function on the quantized components of the macro block in step 515, and encodes image data including the zigzag-operated macro block in step 517. Herein, the controller 101 may encode the image data by Huffman coding. The controller 101 adds a header to the encoded image data in step 519 and compresses the header-added image data in step 521.

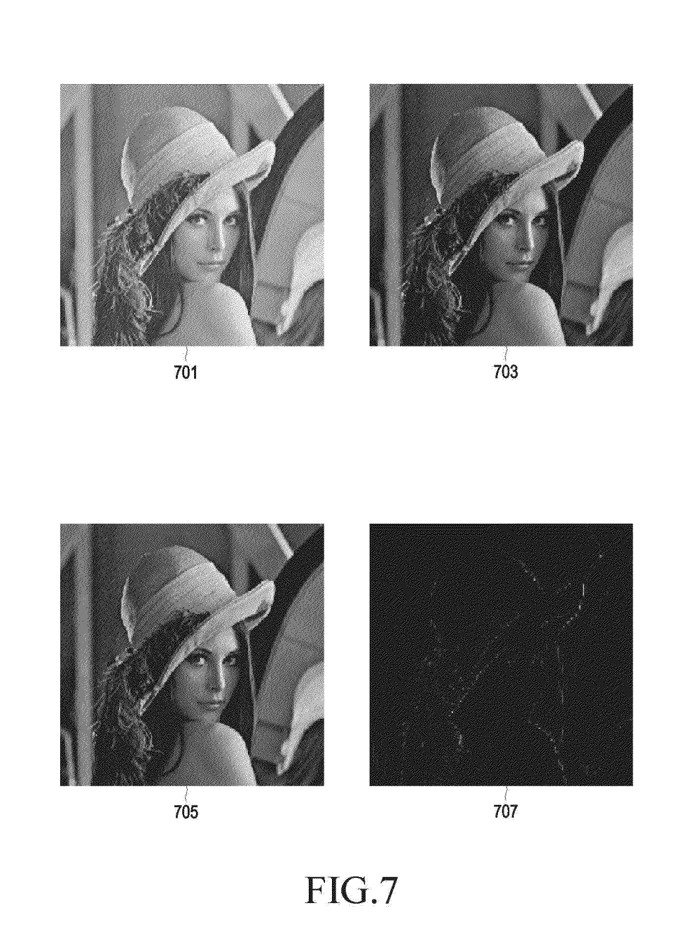

FIG. 7 illustrates image data with transformed luminance according to an embodiment of the present invention.

Referring to FIG. 7, a photo 701 is original image data. It is assumed that the original image data has 8×8 macro blocks, a 512×512 resolution, and an 8-bit gray level. A photo 703 is first image data obtained by transforming the luminance of the photo 701 in a conventional gamma correction method, a photo 705 is second image data obtained by transforming the luminance of the photo 701 in the gamma correction method of the present invention, and a photo 707 illustrates the difference between the first image data and the second image data.

The difference between the first image data and the second image data is calculated using Equation (9):

$$Error [ dB ] = 10 \cdot {log}_{10} \frac{1}{W \cdot H} {\sum }_{0 \leq x < W \\ 0 \leq y < H}^{ } {\vert {I}_{I} ( x , y ) - {I}_{2} ( x , y ) \vert}^{2} \qquad ( 9 )$$

where W denotes the width of an image, H denotes the height of the image, I₁ denotes the gamma of an image corrected by the conventional gamma correction method, and I₂ denotes the gamma of an image corrected by the gamma correction method of the present invention. The pixel values of the image are scaled from a first range from 0 to 255 to a second range from 0 to 1.

The difference between the gamma correction method of the present invention and the conventional gamma correction method, calculated using Equation (9) is −37 dB. Since the difference is negligibly small, the gamma correction method of the present invention offers good image quality, compared to the conventional gamma correction method.

In addition, fast computation is possible in the gamma correction method of the present invention, compared to the conventional gamma correction method. More specifically, given an 8×8 macro block, the conventional gamma correction method requires 4096 multiplications (=8×8×8×8). On the other hand, 63 multiplications using a constant factor suffice in the gamma correction method of the present invention. While a luminance transformation function and the derivative of the luminance transformation function are calculated once per macro block in the gamma correction method of the present invention, as many functions as the number of blocks included in a macro block are calculated in the conventional gamma correction method. For instance, a function is calculated 64 times for an 8×8 macro block in the conventional gamma correction method.

Furthermore, the gamma correction method of the present invention consumes a smaller memory capacity that the conventional gamma correction method.

As is apparent from the above description, when the luminance of image data is transformed in a terminal, the present invention achieves good image quality, enables fast computation, and reduces memory consumption.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. An apparatus for transforming luminance of image data in a terminal, the apparatus comprising:
a memory for storing image data of at least one image; and
a controller for linearly approximating coefficients included in a macro block of the image data and generating image data with a changed luminance, taking into account the linearly approximated coefficients.

2. The apparatus of claim 1, wherein the controller scales a DC component included in the macro block, calculates a luminance transformation function for the DC component, calculates a derivative of the luminance transformation function at the scaled DC component, and approximates the coefficients using the derivative.

3. The apparatus of claim 2, wherein the controller scales the DC component to 0 to 1.

4. The apparatus of claim 1, wherein the controller encodes image data including a macro block including the linearly approximated coefficients, adds a header to the encoded image data, and compresses the header-added image data.

5. The apparatus of claim 4, wherein the controller encodes the image data by Huffman coding.

6. A method for transforming luminance of image data in a terminal, the method comprising:
linearly approximating coefficients included in a macro block of pre-stored image data; and
generating image data with a changed luminance, taking into account the linearly approximated coefficients.

7. The method of claim 6, wherein linearly approximating coefficients comprises:
scaling a DC component included in the macro block, and calculating a luminance transformation function for the DC component;
calculating a derivative of the luminance transformation function at the scaled DC component; and
approximating the coefficients using the derivative.

8. The method of claim 7, wherein scaling the DC component comprises scaling the DC component to 0 to 1.

9. The method of claim 6, wherein generating the image data with a changed luminance comprises:
encoding image data including a macro block including the linearly approximated coefficients;
adding a header to the encoded image data; and
compressing the header-added image data.

10. The method of claim 9, wherein encoding the image data comprises encoding the image data by Huffman coding.
